(19) United States
(12) Patent Application Publication
(10) Pub. No.: US 2022/0352501 A1
(43) Pub. Date: Nov. 3, 2022

(54) BIOMASS DERIVED POROUS CARBON MATERIALS, COMPOSITES AND METHODS OF PRODUCTION

(71) Applicant: Xponential Battery Materials B.V., Amsterdam (NL)

(72) Inventors: Junbing Yang, Placentia, CA (US); Eduardo Munoz, Buenos Aires (AR)

(73) Assignee: Xponential Battery Materials B.V., Amsterdam (NL)

(21) Appl. No.: 17/681,654

(22) Filed: Feb. 25, 2022

Related U.S. Application Data
(60) Provisional application No. 63/153,944, filed on Feb. 25, 2021.

(51) Int. Cl. H01M 4/36; H01M 4/587; H01M 4/58; H01M 10/0525

(52) U.S. Cl. CPC H01M 4/364; H01M 4/587; H01M 4/5815; H01M 10/0525; H01M 2004/028

(57) ABSTRACT

A novel biomass derived catalyst doped porous carbon material and efficient methods to produce it. The doped porous carbon material can be used as a host to generate several materials with a higher performance than exhibited by previous materials. The host material performance enhancement is due to ability to control the amount of doping material, material structure, surface property, and pore size, as well as a high surface area and large pore volume allowing for high sulfur loading. In addition, the hierarchical structure of the porous composites allows an increased in energy density and long cycle life.

### BACKGROUND

### 1. Field of the Invention

The present technology is generally related to a biomass derived porous carbon. More specifically, it is related to a biomass derived catalyst nanoparticles doped porous carbon, a novel sulfur cathode material structures and methods to produce it, and a novel battery configuration using pre-lithiated sulfur cathode, a method to convert biomass to porous carbon and doping catalyst particles in porous carbon, and forming agglomerates of doped porous carbon, sulfur compounds (or lithiated sulfur compounds), and conductive materials.

### 2. Description of Related Art

Lithium-sulfur batteries (LSBs) hold great promise to meet the increasing demand for advanced energy storage beyond portable electronics. For example, a sulfur cathode has a theoretical capacity of 1672 mAh·g⁻¹. This high energy density (˜2,600 Wh·kg⁻¹) of lithium-sulfur batteries. In addition, LSBs have attracted extensive research interest due to the nontoxicity, abundance, and high sustainability of sulfur.

However, the lithium-sulfur (Li—S) cathode suffers from several major challenges, including: (a) poor electronic conductivity of sulfur particles, (b) dissolution of intermediate polysulfides and (c) large volumetric expansion (˜80%) upon lithiation, which results in rapid capacity decay and low Coulombic efficiency.

Despite many efforts in encapsulating sulfur particles with conducting materials to increase conductivity and limit polysulfide dissolution, little emphasis and success has been placed on dealing with the volumetric expansion of sulfur during lithiation, which will lead to cracking and fracture of the protective shell. These challenges become more serious when sulfur loading is increased to the practically accepted level above 3-5 mg cm⁻².

### SUMMARY

The present technology, roughly described, includes a novel biomass derived catalyst doped porous carbon material and efficient methods to produce it. The doped porous carbon material can be used as a host to generate several materials with a higher performance than exhibited by previous materials. The host material performance enhancement is due to ability to control the amount of doping material, material structure, surface property, and pore size, as well as a high surface area and large pore volume allowing for high sulfur loading. In addition, the hierarchical structure of the porous composites allows an increased in energy density and long cycle life.

The present technology also discloses a novel battery configuration using pre-lithiated sulfur cathode coupling with either a Si anode and/or a Li-metal anode. Also disclosed herein is a novel approach to convert biomass to porous biochar, enlarge the pore size of biochar, and convert the biochar to a host porous carbon. The porous carbon can then be functionalized or doped with metal particles that are uniformly distributed in the mesopores.

This present technology further discloses a novel approach to form agglomerates of these materials, including the doped porous carbon, sulfur compounds (or lithiated sulfur compounds), and conductive materials.

### BRIEF DESCRIPTION OF FIGURES

FIG. 1 illustrates a method for forming a sulfur-metal-carbon cathode material from a biomass source

FIG. 2 illustrates the progression of materials in the process of forming a lithium-sulfur battery.

FIG. 3A illustrates a porous composite.

FIG. 3B illustrates agglomerates.

FIG. 3C illustrates a porous carbon.

FIG. 4 illustrates a chart displaying a pore size distribution of mesoporous carbon.

FIG. 5 illustrates a battery structure for a lithium sulphur battery.

FIG. 6 illustrates another method for forming a biomass derived metal particle doped porous carbon material.

FIG. 7 illustrates another method for forming a biomass derived metal particle doped porous carbon material.

FIG. 8 illustrates a method for forming a high capacity sulfur cathode of sulfur metal porous carbon composite from a biomass derived porous carbon material.

FIG. 9 illustrates a method for forming a high capacity sulfur cathode of sulfur solid state electrolyte metal particle porous carbon composite.

FIG. 10 illustrates an agglomerate.

FIG. 11 illustrates a battery structure with a solid state electrolyte.

FIG. 12 illustrates a portion of a mechanofusion system.

FIG. 13 illustrates a system for continuous mixing and wet agglomeration.

### DETAILED DESCRIPTION

The present technology includes a novel biomass derived metal particle doped porous carbon material and efficient methods to produce it. The doped porous carbon material can be used as a host to generate several host materials with a higher performance than exhibited by previous materials. The host material performance enhancement is due to ability to control the amount of doping material, material structure, surface property, and pore size, as well as a high surface area allowing for high sulfur loading. In addition, the high-density consolidated agglomerates have allowed for an increase in energy density.

One of several applications of the doped porous carbon material is a sulfur cathode material structure. The novel sulfur cathode material structure exhibits low swelling, has low electrode expansion, high sulfur loading, and has a high density and long cycle life. The novel material structure of the doped porous carbon material also inhibits polysulfide shuttles.

Also disclosed herein is a novel battery configuration using pre-lithiated sulfur cathode coupling with either a high-capacity Si anode or a Li-metal anode. Also disclosed herein is a novel approach to convert biomass to porous biochar, enlarge the pore size, and convert the biochar to porous carbon. The porous carbon can then be functionalized or doped with catalyst particles that are uniformly distributed in the mesopores.

This present technology also includes a novel approach to form agglomerates of the doped porous carbon with sulfur compounds, electrically conductive material, Lithium-ion conductive material, and a polymer binder. The agglomerates are formed from these materials using a bottom-up approach.

The present technology includes a material that has a three-tier hierarchical structure. The material may include a catalyst doped porous carbon. The doped porous carbon forms an agglomerate with sulfur compounds (lithiated sulfur compounds), electric conductive materials, and a Lithium-ion conductive material, and a binder material. The agglomerate is then processed through a consolidation process to form a porous composite with a hierarchical structure.

The present technology has several advantages. The technology herein is related to battery systems using an electrode in a lithium sulfur battery. Carbonaceous biochar can be derived from biomass source for a low cost. The low-cost biomass derived carbonaceous biochar has a group of many surfaces that are functional. The functional surfaces are polar by nature and can help retrain lithium-polysulfide. Another advantage is that doped catalyst particles can act to increase the strength in retaining the Li-polysulfide.

Some advantages of the present technology are provided by the agglomerate structure. For example, volume expansion in the material structure caused by lithium-polysulfide formation can be mitigated by improved porosity properties inside the agglomerate structure. Additionally, the hierarchical structure further provides multiple barriers preventing lithium-polysulfide to escape from the agglomerates. As a result, the lithium-polysulfide is better retained from shuttling between the cathode and anode during charge and discharge of a lithium-sulfur battery.

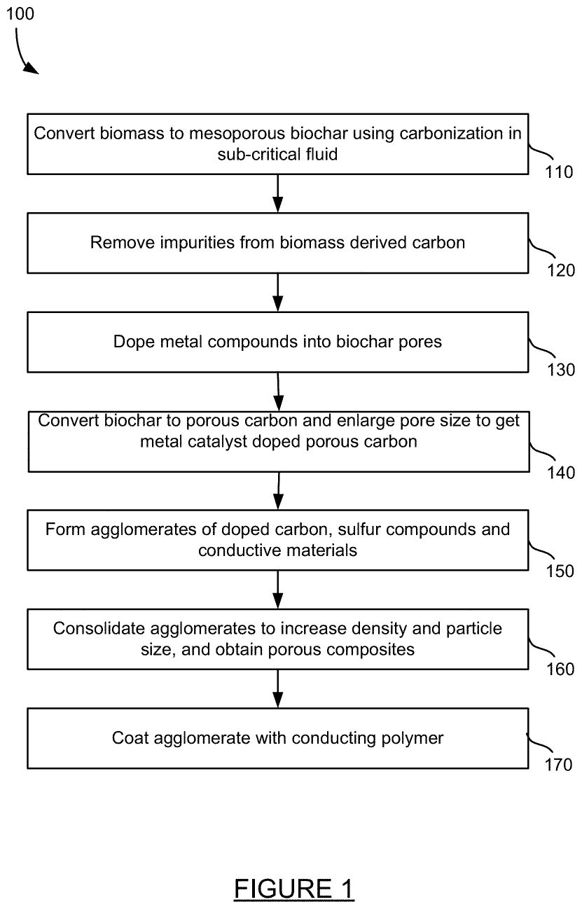

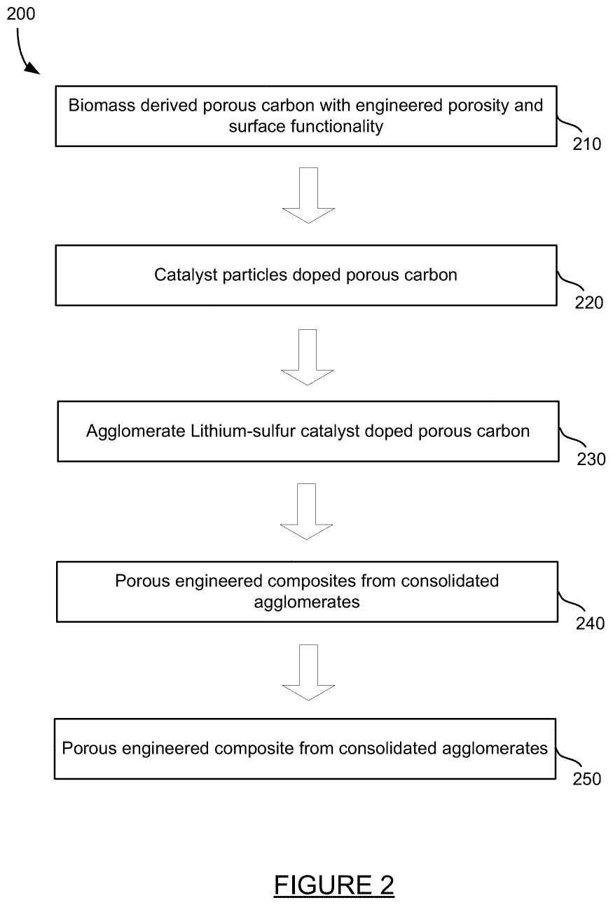

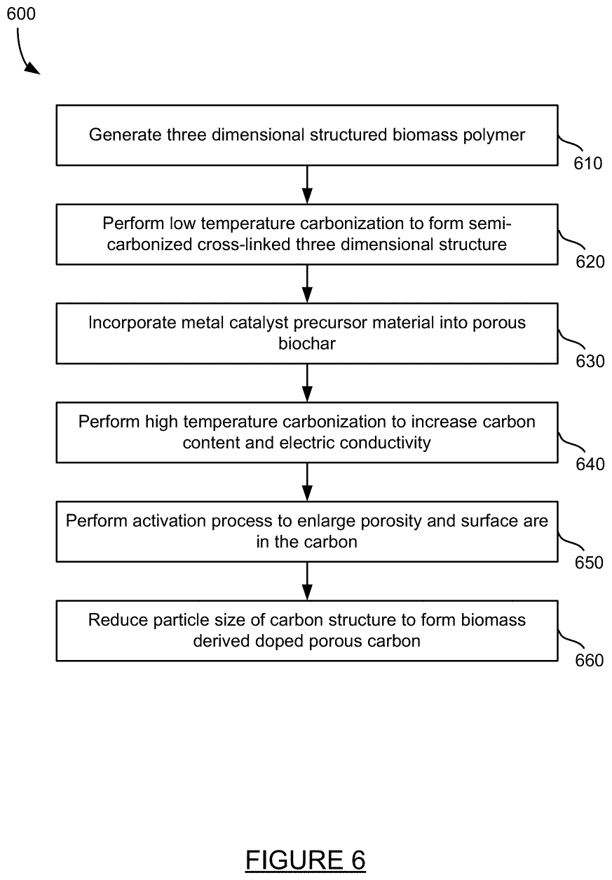

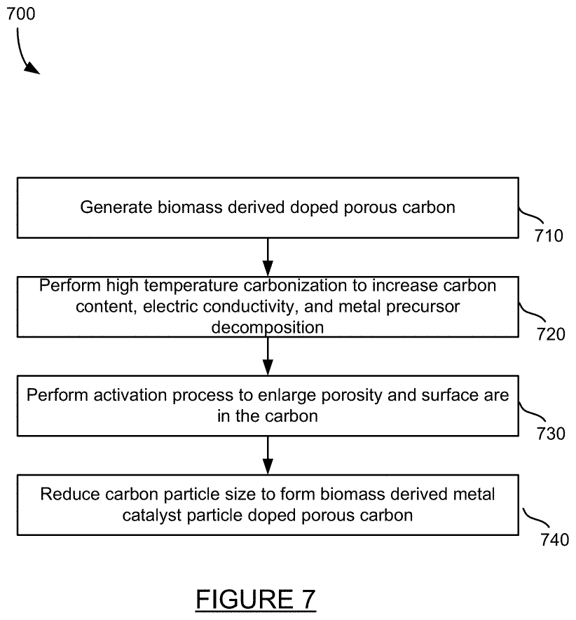

The novel biomass catalyst doped porous carbon material may be produced in several ways. A first method for forming a biomass catalyst doped porous carbon material is discussed with respect to FIG. 1, with the resulting biomass catalyst doped porous carbon material discussed further with respect to FIGS. 2-5. A second method for forming a biomass catalyst doped porous carbon material is discussed with respect to FIG. 6, with the resulting biomass metal doped porous carbon material discussed further with respect to FIGS. 7-10. In some instances, the method of FIG. 6 requires fewer steps and is cheaper than the method of FIG. 1. Additionally, the method of FIG. 6 incorporates a metal precursor into the crosslinked porous polymer during its production from biomass source, and therefore the metal particles are mostly incorporated inside the pore structure after the carbonization and activation process.

FIG. 1 illustrates a method for forming a sulfur-metal-carbon cathode material from a biomass source. The method 100 of FIG. 100 begins with converting a biomass to porous biochar at step 110. The conversion to porous biochar can be performed using carbonization in sub-critical water (hydrothermal carbonization). The hydrothermal carbonization is performed as a sub-critical fluid process to convert the biomass to biochar while keeping the initial porosity of the biochar. The hydrothermal carbonization of biomass includes converting the biomass together with water and at least one catalyst into substances in a pressure vessel by temperature and/or pressure elevation. For example, when a biomass/water mixture is heated to 230-350° C. at a pressure of 500-3000 psi (subcritical conditions), an insoluble carbon-rich black solid (i.e., biochar) and water-soluble products (biocrude) are obtained via a hydrothermal carbonization process.

Using a sub-critical water carbonization process differs from previous methods. Traditional pyrolysis method destroys the initial porosity of the biomass. In traditional torrefaction processes, a biomass is heated to 200-300° C. at near ambient pressure, in the absence of oxygen, to remove moisture and cause some carbonization.

The subcritical water utilized in hydrothermal carbonization has advantages over ambient pressure used in prior methods. For example, subcritical water serves as an excellent reactive medium due to its specific molecular properties. As compared to ambient pressure, subcritical water is significantly different in its dielectric constant, thermal conductivity, ion product, viscosity, and density. Subcritical water can efficiently solubilize many of the biomass components and react them without interfacial-transport limitations.

Impurities can be removed from the biomass derived carbon at step 120. After creating ash in the hydrothermal carbonization process, the ash can be removed from the biomass derived carbon. In some instances, an acid wash or other method can be used to remove ash or select biomass with less ash residue.

Metal compounds can be doped into biochar pores at step 130. Doping can be performed using ion exchange and wet impregnation techniques. The doping results in metal compounds been loaded into the pores of biochar or on the biochar surface. The biochar is negatively charged, which contributes to the electrostatic absorption of the cations.

After doping, a high temperature treatment is applied to convert the metal compound doped biochar to metal doped porous carbon at step 140. A mild oxidation in water steam or carbon dioxide at 700-900° C. can then be performed to enlarge the pore size and surface oxidation of metal particles, such as for example the metal oxide layer on the surface of the porous carbon.

Agglomerates of the doped porous carbon with sulfur compounds and conductive materials are formed at step 150. The agglomerates are formed using a bottom-up approach. In some instances, a novel multi-phase wet agglomeration is used in a fast turbulent flow-based bottom-up approach. The bottom-up wet agglomeration process controls the porosity of the agglomerates in an improved manner as compared to a traditional mill(mix)-hot press (melt)-pulverize-sieve approach. The process includes a uniform mixing of sulfur with porous carbon and metal oxide through the bottom-up approach. The agglomeration process includes doped porous carbon, sulfur compounds, conductive carbon, and binder. Through this process, it is easy to form and control the porosity of the formed agglomerates. In some instances, the the sulfur compounds comprise about 10 weight percent to about 80 weight percent of the composite. In some instances, the sulfur compounds can include one or more of a sulfur element, small sulfur molecules, and lithium disulfide or sulfide.

In principle, the wet agglomeration in fast turbulent flow creates a strong turbulence for the powder added during the process. Powder is continuously fed from the top of an agglomeration system, while turbulence provides the combined force to the powder swirl, rotation and compression. In this turbulent mixing stage, liquid is also injected for mixing and uniform wetting. In case of higher humidification, powder is wetted for large agglomerates, and it is repeatedly wrapped up by sprayed liquid drops and grows into porous and large agglomerates.

The novel wet agglomeration in fast turbulent flow can be performed using any of several suitable agglomeration systems. One example of such a system is the Flexomix continuous agglomeration system, made by Hosokawa Micron Corporation of Japan.

Once formed, the agglomerate can be coated with a conducting polymer, carbon, TiO₂, or other suitable conductive material at step 160. The coating creates a robust shell for the agglomerated nanocomposite.

FIG. 2 illustrates the progression of materials in the process of forming a lithium-sulfur battery. In FIG. 2, the material starts off as biomass, which is then used to derive porous carbon as shown at stage 210. The porous carbon may take the form of a porous carbon element, wherein the pores have a pore size in the range of 2-100 nanometers (nm) and a particle size in the range of 2-20 micrometers. The porous carbon is engineered with porosity and surface functionality. The porous carbon is then doped with metal oxide-based catalyst at stage 220. The catalyst nanoparticles can include, for example, metallic metals, metal oxides, metal nitrides, or metal sulfides. The catalyst particles can be deposited inside the pores or on the surface of the porous carbon element. The catalyst particles (i.e., nanoparticles) can have a particle size in the range of 2-100 nm. The catalyst loaded porous carbon is then doped with sulfur compounds (or lithiated sulfur compounds) at stage 230. The doped porous carbon is then engineered into porous particles at stage 240. The porous composite includes a plurality of agglomerates, wherein the agglomerates are isotropic in nature and the porous composites represent a hierarchical structure. The porous composite is used in a lithium-sulfur-silicon-carbon or Li-metal cell of a lithium battery at stage 250.

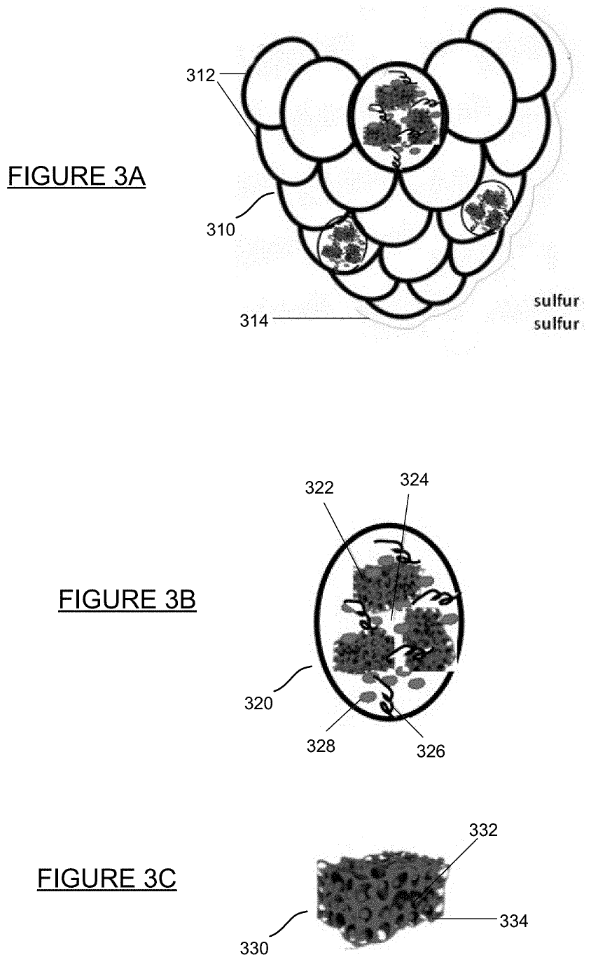

FIGS. 3A-3C illustrate a hierarchical structure of the porous composite comprising agglomerates of doped carbon, sulfur and conductive materials. FIG. 3A illustrates a porous composite 310. The porous composite includes multiple agglomerates 312 that each include doped carbon, sulfur, and conductive materials, and sulfur and conductive materials 314. The porous composite 310 can be coated with a lithium-ion permeable layer. In some instances, the electrically conductive material includes carbon black, carbon nanotubes, conductive polymers, or graphene.

FIG. 3B illustrates a single agglomerate 320. The agglomerate 320 can be a metal-sulfur-carbon, and can includes metal doped carbon, sulfur and conductive materials. In particular, the agglomerate 320 includes doped porous carbon 322, pores 324 between doped porous carbon elements 322, electrically conductive material 326, and sulfur or lithiated sulfur compounds 328. FIG. 3C illustrates a doped porous carbon element. The doped porous carbon element 330 included catalyst particles 332 and pores 334 that make up the porous structure within the carbon and or on its surface.

As can be seen in FIGS. 3A-3C, there can be at least three different types of pores. For example, there are pores inside the porous carbon which take the form of holes and apertures within the porous carbon itself. Within an agglomerate, there are pores between neighboring porous carbon elements that are contained inside the agglomerate. Additionally, there are pores between neighboring agglomerates.

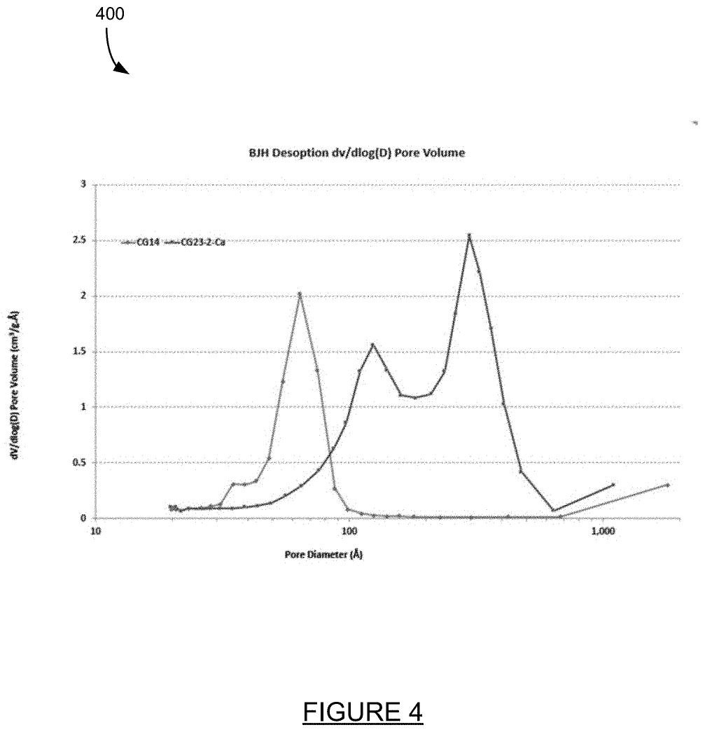

FIG. 4 illustrates a chart displaying a pore size distribution of porous carbon. As shown, illustration 400 illustrates the pore diameter (A) vs. the dV/dlog(D) Pore Volume (cm\hat{ }3/g). A plot for carbon BMC-1 remains low for much of the pore diameter, but spikes at a pore diameter less than 100. A plot for carbon BMC-2 has a gradual increase in pore volume, and experiences two spikes between a pore diameter of 100 Å and 1000 Å.

A first example of an instance of the present technology will be described. In some instances, agglomerates, for example metal-sulfur-carbon can be produced according to the techniques of the present technology. The process may include mixing metal chloride with a biomass, biomass derived polymer, or other polymer. A metal ion containing porous polymer may undergo carbonization and activation. The carbonization and activation of the metal ion may result in a doped porous carbon. The doped porous carbon can undergo grinding, milling, and screening to obtain a preferred particle size and distribution.

The doped porous carbon can then be impregnated with sulfur. In some instances, a wet agglomeration in fast turbulent flow process is used to incorporate and glue sulfur particles into the doped porous carbon. This process forms agglomerated particles. The wet agglomeration can be performed using any of several suitable systems, including but not limited to a Schugi® Flexomix FXD-100 (made by Hosokawa Micron Corporation of Japan). The formed agglomerates have several benefits, including but not limited to a more uniform and higher content mix of sulfur with doped porous carbon, which is achieved through a more gentle and mild process without damaging the pre-formed doped porous carbon structure. Further, a wet agglomeration process creates more porosity within the agglomerates, which is advantageous because it accommodates the cathode volume change during the charge and discharge process in a Lithium Sulfur battery.

After impregnation with sulfur and formed the agglomerates, the sulfur incorporated doped porous carbon agglomerates are consolidated to increase its tap and pack density, particle size through a mix-compaction-crush-sieve process. Compared to the traditional mill(mix)-hot press (melt)-pulverize-sieve approach, this mix-compaction-crush-sieve process use much less force in the mix and compaction process since the components have already premixed within the agglomerates. The compaction step can also be tuned to adjust the porosity within the agglomerate. The outcome of this consolidation process is a porous composites of higher tap density, larger particle size with more controlled porosity. The porous composites are then coated to form a rigid shell. The coating material may be a conducting polymer glue, TiO₂, or carbon black mixed PVDF binder. The formed shell will not break due to a large volume expansion during a charging process of a cell that utilizes the porous composite cathode. The porous composite cathode is then heated to melt the sulfur and the sulfur penetrates the carbon mesopores surrounding the catalyst particles, thereby forming the final structure.

The process of this first example provides several advantages over existing processes. First, the process involves a homogenous mix of sulfur with doped carbon. Another advantage is that the sulfur further penetrates the mesopores of doped porous carbon. The sulfur further surrounds the catalyst particles inside the pores. A further advantage is that the catalyst facilitates large volume of sulfur penetration into the porous carbon. The bottom-up agglomeration process to form initial high porosity in the agglomerates and porosity adjustment in the subsequent consolidation process produces a porous composite cathode with better controlled porosity than other methods. Controlled porosity in the composite cathode is advantageous as it enables high performance of a Lithium Sulfur battery.

A second example of an instance of the present technology involves producing agglomerates of metal-lithium sulfide-carbon. The agglomerates can be formed, for example using a Hosokawa Fluidized Agglomerator, which is a batch type fluidized agglomerator with a unique rotating disk for combining a tumbling and agitating agglomeration operation by integrated blades. One cycle may include mixing, agglomeration, drying, and cooling processes to produce a powdery material. Particle size and bulk density can be controlled by controlling the machine operating conditions.

A molecular-level dense metal-sulfur-carbon composite can be formed by carbonizing the agglomerated nanocomposites, such as oxygen and nitrogen rich carbon and sulfur, metal particles, at a high temperature, for example a temperature of up to 600° C. In some instances, wherein the biomass or polymers are oxygen-rich organic material perylenetetracarboxylic dianhydride and a nitrogen-rich polymer polyacrylonitrile. At this temperature, octasulfur (S₈) is decomposed into sulfide (S₂) and tri-sulfur (S₃) and bonded to carbon and other elements in the porous carbon element. The result is that a molecular-level dense metal-sulfur-carbon composite is formed.

In another example of an instance of the present technology, the agglomerates can be formed using a spray drying process.

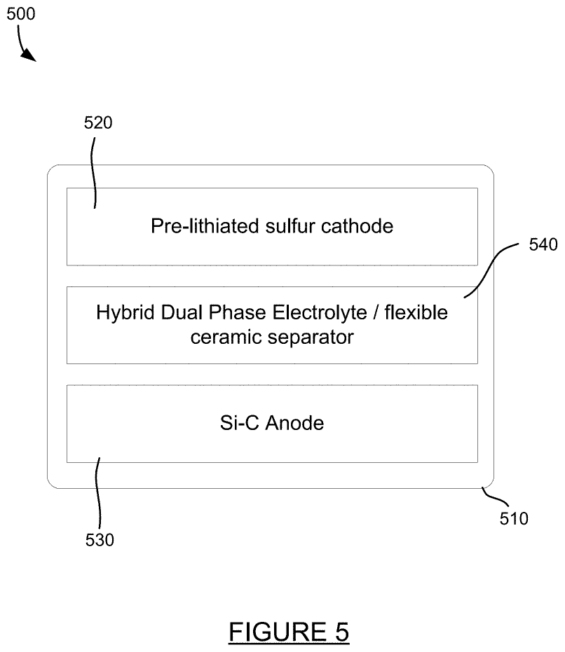

FIG. 5 illustrates a battery structure for a lithium sulfur battery. The lithium sulfur battery 510 includes a cathode 520, anode 510, and a separator 540. The cathode can include a pre-lithiated sulfur cathode. The anode can include a silicon-carbon anode. The separator can include a flexible ceramic separator containing various aromatic polyamide synthetic fibers. The synthetic fibers can help block polysulfides from traveling through the separator membrane and reducing the negative shuttle impact within the battery structure. The anode, cathode, and separator form a battery structure for a lithium sulfur battery that exhibits the advantages discussed herein.

FIG. 6 illustrates a method for forming a biomass derived metal doped porous carbon material. A three-dimensional crosslinked porous polymer from biomass source is generated at step 610. In some instances, the cross-linked polymers are polymers in which long polymer chains are cross-linked together to create a three dimensional network. Examples of these polymers include bakelite, melamine and formaldehyde resin. The crosslinked porous polymer can be generated from a mechanochemical synthesis process which uses a biomass carbon source. The biomass carbon source can include tannin, gallic acid, lignin, cellulose, sucrose, or some other biomass material. A tannin, for example, is an astringent biomolecule extracted from plants and fruits. Gallic acid is an antioxidant-type organic acid present in many plants. It is also part of the composition of some tannin. A lignin is a class of complex organic polymers that form key structural materials in the support tissues of most plants.

A low temperature carbonization process is performed at step 620. The low temperature carbonization forms a semi-carbonized porous Biochar. In some instances, a low temperature carbonization process occurs at a temperature up to 400° C. This process removes unreacted surfactant, crosslink agent used in the porous polymer synthesis step and converts the porous polymer into semi-carbonized cross-linked biochar. The low temperature carbonization process reduces shrinkage and preserves material porosity in the resulted porous biochar. In some instances, the low temperature treatment can be performed in air, inert gas, or in a subcritical fluid such as water or carbon dioxide.

A catalyst precursor is incorporated into the porous biochar at step 630. The low temperature carbonization process of step 620 retains the surface functional group of the crosslinked biomass molecular and the porosity between the polymer chains. As such, it is easier to incorporate a catalyst precursor into the porous biochar.

The catalyst precursor penetrates the biochar porous structure through absorption in an ion exchange process. This absorption and exchange process help uniformly retain the metal precursor during the drying process. In some instances, the metal precursor can be incorporated into the semi-carbonized biomass derived porous polymer through solid state mixing, or wet impregnation by dissolving the metal precursor in a solvent.

A high temperature carbonization is performed at step 640. The high temperature carbonization increases carbon content and increases conductivity in the material. In some instances, the high temperature carbonization process can be performed at temperatures between 800-900° C. to fully convert the semi-carbonized biochar to carbon. This high temperature process results in an increase in carbon content and electric conductivity of the porous carbon.

An activation process is performed on the carbon structure at step 650. The activation process acts to react the metal doped porous carbon with water steam or carbon dioxide in high temperatures, such as for example between 800 to 900° C. The activation process serves to enlarge the porosity and surface area in the porous carbon, both for micropores and mesopores. The activation process keeps the material pores pristine, retains larger pores, and adds surface functional group to carbon.

The particle size of the carbon structure is reduced at step 660. The particle size reduction can be achieved using a mechanical milling approach to get the size of the doped porous carbon to, for example, 3-5-microns in diameter.

The biomass derived carbon is typically hard carbon, and previous systems had difficulty to achieve particle size reduction. In the present process, after activation, the surface area and pore volume were increased, which makes it much easier to reduce the particle size through mechanical milling.

In some instances, generating a three-dimensional structured porous polymer from biomass source can be performed through a mechanochemical method using a mechanofusion system, such as for example a mechanofusion using an AMS-30F mixer commercially available from Hosokawa Micron Corporation. In the mechanofusion system, a powder material is delivered through slits on rotary walls of the mixer. The powder is carried up above the rotors by rotor-mounted circulating blades. Subsequently, the material returns again to the rotors where it is are subjected to strong compression and shearing forces from the inner portion of the rotor. This cycle of both three-dimensional circulation and effective compression/shearing of the powder material is repeated at high speeds, thereby forming it into a composite electroactive material (powder). In some instances, generating a three-dimensional structured porous polymer from biomass source can include a high energy ball mill.

A three-dimensional crosslinked porous polymer with built-in metal catalyst precursors can be produced in several ways. One way for producing the three-dimensional crosslinked porous polymer with built-in metal catalyst precursors involves using a rotary container. First, powder materials are placed in a container. The powder materials can include a carbon source chestnut tannin extract (100 g), a structure-directing agent pluronic F127 (100 g), and a crosslinking agent glutaraldehyde (45 g), and a metal source Nickel(II) acetate tetrahydrate [Ni(OAc)2 H2O] (50 g). In general, the powder materials (chestnut tannin extract, pluronic F127 and glutaraldehyde) are placed in a rotary container and are subjected to centrifugal force and securely pressed against the wall of the container. The powder materials undergo strong compression and shearing forces when they are trapped between the wall of the container and the inner piece of the rotor with a different curvature. Particles of the material are brought together with such force within the machine that they adhere to one another. In some instances, after three hours, the metal source [Ni(OAc)2 H2O] is then added to the Tannin/Pluronic/glutaraldehyde mix and then undergoes strong compression and shearing forces for an additional period of time, such as for example 1 hour.

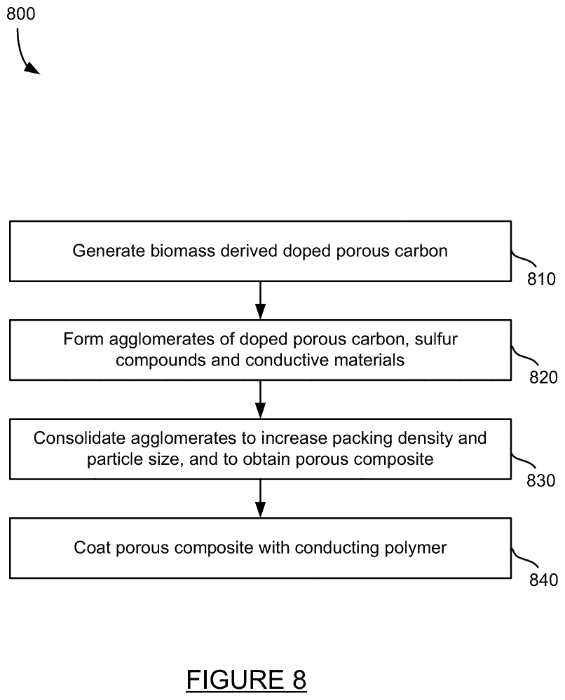

The method of FIG. 6 results in forming a biomass derived metal doped porous carbon. The biomass derived metal doped porous carbon can be used as a host or base material to produce several useful products, battery components, and materials. For example, the biomass derived metal doped porous carbon can be used as a host to form high capacity cathodes as discussed with respect to FIGS. 7 and 8.

FIG. 7 illustrates another method for forming a biomass derived metal particle doped porous carbon material. The method 700 of FIG. 7 sets forth another method to produce carbon, and is similar to the method of FIG. 6 but with some additional steps. First, a biomass derived doped porous carbon is generated at step 710. Step 710 represents the steps in the method of FIG. 6. After performing the steps of FIG. 6, a high temperature carbonization is performed at step 720. The high temperature carbonization is to increase carbon content, electric conductivity, and metal precursor functionality.

An activation process is performed at step 730. The activation process works to enlarge porosity and increase the surface area in the carbon material. The carbon particle size is reduced at step 740. The reduction in carbon particle size forms a metal catalyst particle doped porous carbon. The doped porous carbon formed at step 740 is formed from and/or derived from biomass. The doped porous carbon has pores, such as holes and apertures extending through the structure of the carbon, and catalysts inside the porous structure.

FIG. 8 illustrates a method for forming a high capacity sulfur cathode of sulfur metal porous carbon composite from a biomass derived metal doped porous carbon material. First, a biomass derived doped porous carbon is generated at step 810. Step 810 represents the steps in the method of FIG. 6.

After performing the steps of FIG. 6, agglomerates are formed at step 820. The agglomerates are formed of doped porous carbon, sulfur compounds, and conductive materials. In some instances, this is performed through traditional mixing followed by melting process to prepare sulfur cathode. For example, step 820 can include grinding and mixing elemental sulfur and the metal doped porous carbon and conductive carbon by a mixer to obtain a sulfur-carbon mechanical mixture

Agglomerates can be consolidated at step 830. The agglomerate consolidation can increase tap, packing density and particle size, and results in obtaining a porous composite. The agglomerate consolidation also include hot pressing the sulfur-carbon mechanical mixture by using a pressing die to melt the sulfur into the carbon pores and obtain a sulfur-carbon block material. The step can also include grinding and sieving the sulfur-carbon block materials to prepare the sulfur-metal-porous carbon cathode materials.

The porous composite is coated with conducting polymer at step 840. Once formed, the agglomerate can be coated with a conducting polymer, carbon, TiO₂, or other suitable conductive material at step 160. The coating creates a robust shell for the agglomerated nanocomposite.

The method of FIG. 8 is advantageous as it produces a biomass and then, via the agglomeration process, is able to increase and control the porosity.

In some instances, the process of FIG. 8 result in a material that increases the tap density of the sulfur-metal doped porous carbon. A material with an increased tap density makes it easier for electrode processing. The method of FIG. 8 also results in an increase the volumetric energy density of the sulfur cathode electrode and batteries. In some instances, the conductive carbon includes carbon black, carbon nanotube and graphene. In some instances, the preferred particle size of the sulfur-metal-porous carbon cathode materials is D50 in the range of 15 to 20 micron.

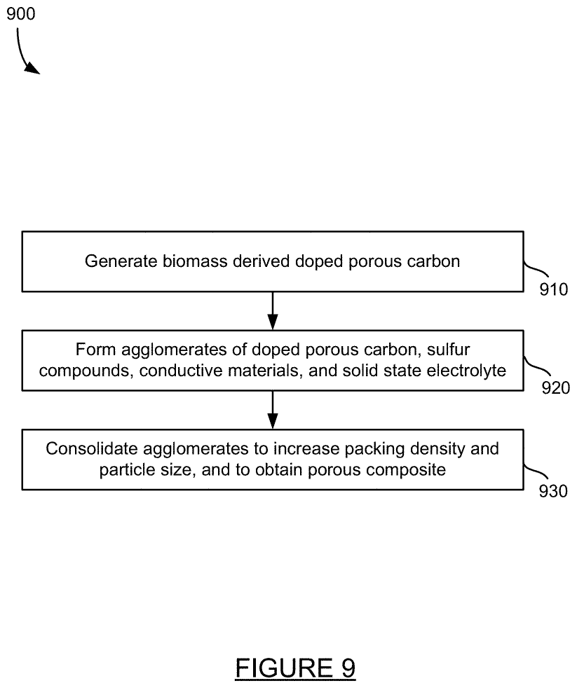

FIG. 9 illustrates a method for forming a high capacity sulfur cathode of sulfur solid state electrolyte sulfur metal particle porous carbon composite. First, a biomass derived doped porous carbon is generated at step 910. Step 910 represents the steps in the method of FIG. 6.

After performing the steps of FIG. 6, agglomerates are formed at step 920. The agglomerates are formed of doped porous carbon, sulfur compounds, conductive materials, and solid state electrolyte. The agglomerates are generated by adding solid state electrolyte in a milling mixing step. Some types of solid-state electrolytes are air sensitive, as such, portions of method 900 may need to be performed under inert gas protection to prevent solid state electrolyte from reacting with certain component in the air. In some instances, the solid state electrolyte is incorporated into the porous carbon during an agglomeration process.

The agglomerates are then consolidated at step 930 to increase the packing density and particle size, as well as to obtain a porous composite.

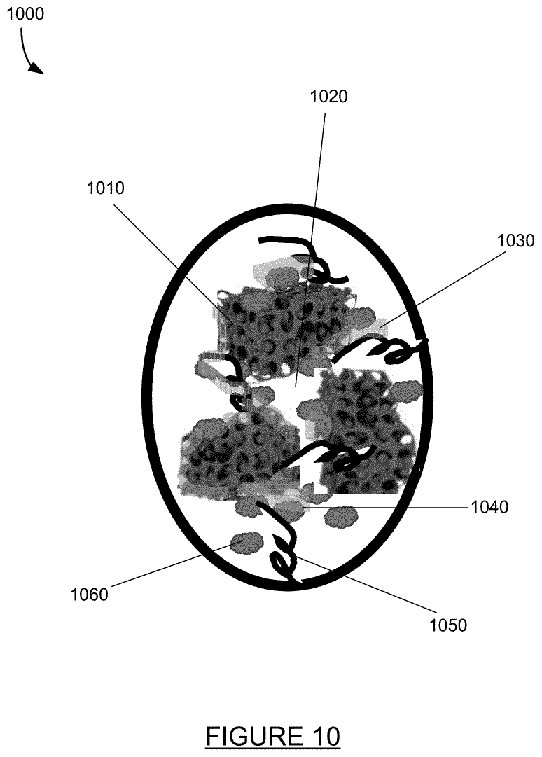

FIG. 10 illustrates an agglomerate 1000 comprising doped porous carbon particles, sulfur compounds, electrically conductive materials, and solid state electrolyte, the triple-phase boundary inside the agglomerates. The agglomerate 1000 includes doped porous carbon 1010, pores 1020 between the doped porous carbon elements 1010, a solid state electrolyte 1030, electrically conductive material 1050, and sulfur or lithiated sulfur compounds 1060. The elements within agglomerate 1000 can include triple phase boundaries 1040. The hierarchical structured porous polymer with agglomerate creates sufficient sulfur/conductive support/solid electrolyte triple-phase boundaries, where the sulfur, conductive element, and solid electrolyte interact and/or have a three surface connection or boundary, which allows high ionic and electric transport under high sulfur loading. The electrically conductive material may include, for example, conductive nanotube.

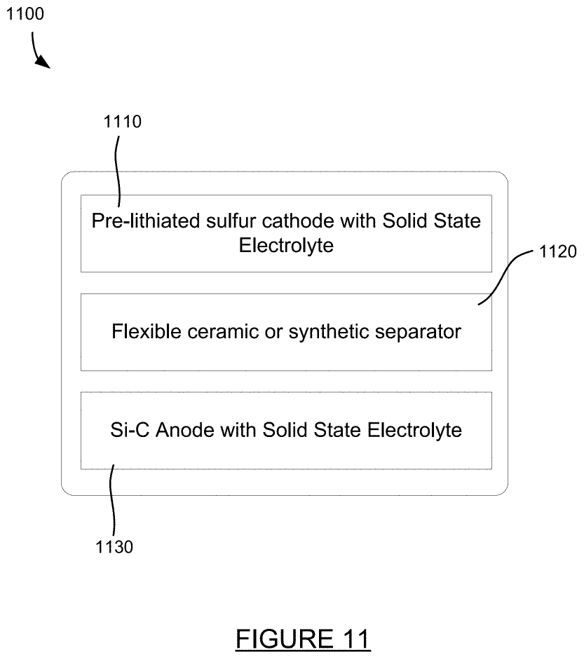

FIG. 11 illustrates a battery structure with a solid state electrolyte. The battery structure 1100 includes cathode 1110, a separator 1120, and an anode 1130. The cathode can be implemented as a pre-lithiated sulfur cathode with a solid state electrolyte. The separator can be implemented as a flexible ceramic or synthetic fiber separator. In some instances, the synthetic fiber separator may filter materials with a controlled porosity to allow a lithium ion to pass while inhibiting lithium polysulfide molecules from passing. The anode can be implemented as a Silicon-carbon anode with a solid state electrolyte.

In some instances, the process and methods disclosed herein may include a mechanochemical reaction process and the continuous mixing and wet agglomeration process. A mechanochemical reaction system may be used for doped porous carbon production from biomass. The processing occurs, for example, using a mechanofusion process that is performed using an AMS-30F mixer commercially available from Hosokawa Micron Corporation. In the mechanofusion system, the powder material is delivered through slits on the rotary walls. It is carried up above the rotors by the rotor-mounted circulating blades. Subsequently, the material returns again to the rotors where it is are subjected to strong compression and shearing forces from the inner pieces of the rotor. This cycle of both three-dimensional circulation and effective compression/shearing of the powder material is repeated at high speeds, thereby forming it into a composite electroactive material (powder).

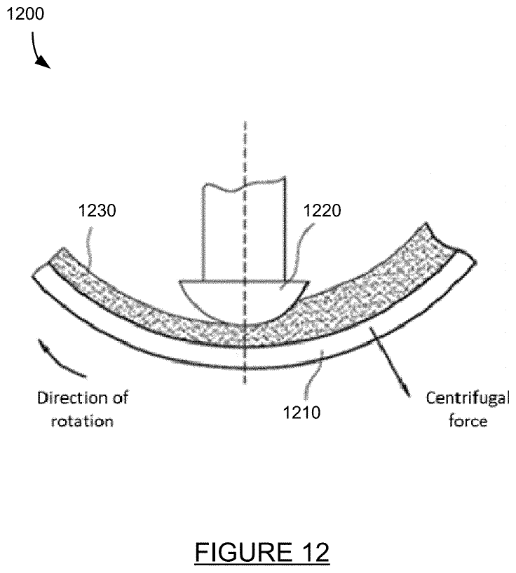

FIG. 12 illustrates a portion of a mechanofusion system. The system 1200 of FIG. 12 includes a container 1210 and an inner piece 1220. In operation, the biomass source, structure directing agent, and crosslinking agent materials (1230) are placed on an inner concave surface of the container. The inner piece is then displaced over the concave surface and the materials. By rotating the container, the inner piece applies a centrifugal force against the materials and the container, thereby forming the materials into a composite electroactive material (powder).

In some instances, the process and methods disclosed herein may include continuous mixing and wet agglomeration in fast turbulent flow process for agglomerates production.

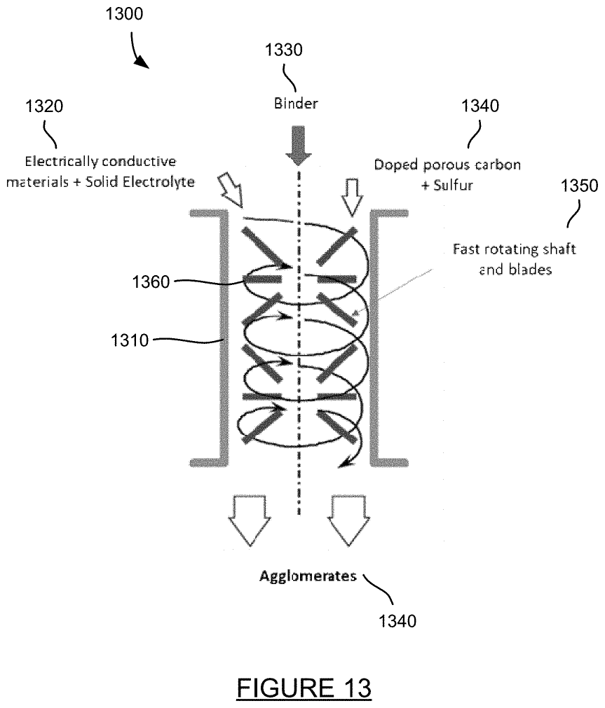

A system for continuous mixing and wet agglomeration is illustrated in FIG. 13. In system 1300 of FIG. 13, a system for continuous mixing and wet agglomeration 1300 includes a chamber 1310. The process begins with powders 1320 (doped porous carbon/sulfur/electrically conductive materials, and solid electrolyte) being continuously fed, for example from the top in some systems, to an agglomeration system chamber. The fast turbulent flow in the chamber 1310 caused by the fast rotating of the shaft and the blade 1360 and 1350 provides combined forces to the powder swirl, rotation, and compression. A binder 1330 in liquid solvent can be injected for mixing and uniform wetting. The powders are then wetted, repeatedly wrapped up by sprayed liquid binder drops, and the powder grows into porous and large agglomerates.

The continuous mixing and wet agglomeration in fast turbulent flow creates a strong turbulence for the powder added during the process. The agglomerates are formed using a bottom-up approach. The bottom-up wet agglomeration process controls the porosity of the agglomerates in an improved manner as compared to a traditional mill(mix)-hot press (melt)-pulverize-sieve approach.

The doped porous carbon formed by the present system is a novel material. The method for forming the material is just as important. Advancements to achieve a sustainable, very high energy density, and lower cost lithium ion battery have been hindered by a variety of performance issue. The performance issues are primarily caused by negative chemical interaction issues that occur during battery cycling.

The novel biomass derived porous carbon host material generated herein has the ability to overcome some of the current battery electrode material negative challenges while substantially improving lithium battery energy density and extend cycle life, enabling a commercially viable lithium sulfur battery. The Li—S host material performance enhancement is due to the ability to control the amount of doping material, material structure, surface property, and material pore size, as well as a high surface area and large pore volume allowing for high sulfur loading. In addition, the hierarchical structure of the porous composites from consolidated agglomerates allows an increased in energy density and long cycle life. By focusing on developing a highly scalable biomass-based carbon host, along with complimentary advanced unique battery separators, electrolytes, additives, and binder materials, this invention aims to bring to life to a novel very high energy density and lower-cost next generation battery design for electric vehicles and energy storage systems. The present LSB invention fulfills these needs and provides further related advantages.

In general terms, the current technology discussed herein is directed to a novel carbon material comprised of a variety of processed biomass byproducts (i.e., tannins, lignans, stalks, shells, etc.). the porous carbon material creates a highly structured porous host material with engineered micro and mesopores. Together with a high surface area, the doped porous carbon material will accommodate both higher amounts of sulfur loading, including an electrochemical catalyst and electrolyte within its pore structure to greatly enhances LSB energy density and cycle life performance. The novel carbon material pores create a special closeness and connection between the active Li—S materials to the electrolyte creating a shorter ion migration path, reducing the polysulfide shuttle effect to permit better energy performance with a high cycle life relative to other known Lithium batteries.

The foregoing detailed description of the technology herein has been presented for purposes of illustration and description. It is not intended to be exhaustive or to limit the technology to the precise form disclosed. Many modifications and variations are possible considering the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A porous composite, comprising:
a plurality of agglomerates, wherein each of the agglomerates comprises:
a porous carbon having pores, wherein the pores have a pore size in the range of 2-100 nanometers and a particle size in the range of 2-20 micrometer;
catalyst nanoparticles deposited inside the pores or on the surface of the porous carbon, the catalyst nanoparticles having a particle size in the range of 2-100 nm;
a sulfur compound deposited inside the pores or interspersed among the porous carbon; and
electrically conductive material interspersed among the porous carbon and inside a plurality of porous carbon elements with the sulfur compounds,
wherein the agglomerates are isotropic in nature and the porous composites represent a hierarchical structure from the agglomerates.

2. The porous composite of claim 1, further comprising a lithium-ion permeable layer coated on at least a portion of a surface of the porous composite, wherein the lithium-ion permeable layer comprises carbon, polymer, and metal oxide.

3. The porous composite of claim 1, wherein each of the plurality of agglomerates include pores formed within the agglomerate and between two or more porous carbon, sulfur compounds and electrically conductive material within the agglomerate,
and wherein pores are formed between two or more agglomerates within the porous composite.

4. The porous composite of claim 1, wherein the sulfur compounds comprise about 10 weight percent to about 80 weight percent of the composite.

5. The porous composite of claim 1, the porous carbon including an oxygen-rich or a nitrogen rich carbon host, the carbon host made from biomass or polymers that are oxygen-rich or nitrogen rich.

6. The porous composite of claim 5, wherein the biomass or polymers are oxygen-rich organic material perylenetetracarboxylic dianhydride and a nitrogen-rich polymer polyacrylonitrile.

7. The porous composite of claim 1, wherein the catalyst nanoparticles include metallic metals, metal oxides, metal nitrides, or metal sulfides.

8. The porous composite of claim 1, wherein the sulfur compounds include one or more of a sulfur element, small sulfur molecules, and lithium disulfide or sulfide.

9. The porous composite of claim 1, wherein the electrically conductive material includes carbon black, carbon nanotubes, conductive polymers, or graphene.

10. The porous composite of claim 1, wherein a molecular-level dense metal-sulfur-carbon composite is formed by carbonizing the agglomerates, the agglomerates including metal particles, oxygen and nitrogen rich carbon, the molecular-level dense metal-sulfur-carbon composite formed at a temperature up to 600° C.,
wherein S₈ is decomposed into S₂ and S₃ and bonded to carbon and other elements in the porous carbon element, forming a molecular-level dense metal-sulfur-carbon composite.

11. A method for deriving porous carbon from biomass, comprising:
converting a biomass to porous biochar;
removing impurities from the porous biochar;
doping the porous carbon with catalyst nanoparticles having a size of the mesopores;
converting the porous biochar to porous carbon; and
enlarging a pore size of the catalyst doped porous carbon;

12. A process to form agglomerates of doped porous carbon and sulfur compounds using a wet agglomeration in fast turbulent flow-based bottom-up approach.

13. A lithium-sulfur battery electrode, comprising:
a conductive metal substrate; and
a porous composite dispersed in a binder, the binder coupled to the conductive metal substrate, wherein the porous composite comprises:
a plurality of agglomerates, wherein each agglomerate includes a porous carbon having a pores within the porous carbon structure, catalyst nanoparticles deposited inside the pores, and a sulfur compound deposited inside the pores, and
an electrically conductive material joining the agglomerates together, wherein at least a portion of the agglomerates are in electrical communication with each other through the electrically conductive material.

14. The lithium sulfur battery electrode of claim 13, the plurality of agglomerates each including catalyst materials on the surface of each of the plurality of agglomerates.

14. A battery structure, comprising:
a metal-lithium sulfide-carbon composite cathode;
a silicon composite or a Li-metal anode;
a flexible ceramic or synthetic fiber separator; and
a gel dual phase electrolyte.

15. The battery structure of claim 14, wherein the battery is a Cobalt-free high energy density electrochemical energy storage device.

16. A method for forming a biomass derived metal doped porous carbon material, comprising:
generating a three-dimensional crosslinked porous polymer from a biomass source;
performing low temperature carbonization on the porous polymer to generate a semi-carbonized porous biochar;
incorporating a catalyst material into the semi-carbonized porous biochar;
performing a high temperature carbonization on the semi-carbonized porous biochar;
performing an activation process for a catalyst incorporated into porous carbon to form a doped porous carbon; and
reducing the particle size of the doped porous carbon.

17. The method of claim 16, wherein the three-dimensional crosslinked porous polymer from the biomass source is produced through a mechanochemical method using a mechanofusion mixer.

18. The method of claim 17, wherein a three-dimensional crosslinked porous polymer with built-in metal catalyst precursors is produced by adding the metal catalyst precursor into a reactor at a late stage of the mechanochemical method.

19. The method of claim 16, wherein the low temperature carbonization process prepares a semi-carbonized three-dimensional porous structure.

20. The method of claim 16, wherein the low temperature carbonization is performed at a temperature up to 400 degrees Celsius.

21. The method of claim 16, wherein the high temperature carbonization process increases the electric conductivity of the carbon material.

22. The method of claim 16, wherein the high temperature carbonization is performed at a temperature between 800-900 degrees Celsius.

23. The method of claim 16, further comprising incorporating sulfur into the porous carbon material to generate a sulfur-carbon mixture.

24. The method of claim 23, further comprising processing the sulfur-carbon mixture to generate a material that is D50 in the range of 15 to 20 microns.

25. The method of claim 16, further comprising incorporating solid state electrolyte into the carbon material.

26. A porous composite, comprising:
a plurality of agglomerates, wherein each of the agglomerates comprises:
a porous carbon matrix having pores, wherein the pores have a pore size in the range of 2-100 nm and a particle size in the range of 2-20 micrometer;
catalyst nanoparticles deposited inside the pores or on the surface of the porous carbon matrix, the metal nanoparticles having a particle size in the range of 2-50 nm;
a sulfur compound deposited inside the pores or interspersed among the porous carbon matrix;
electrically conductive material interspersed among the porous carbon matrix and sulfur compounds;
a solid-state electrolyte interspersed amount the porous carbon matrix and sulfur compounds; and
triple-phase boundaries of sulfur compounds, electrically conductive materials, and solid-state electrolyte,
wherein the agglomerates are isotropic in nature and the porous composites represent a hierarchical structure from the agglomerates.

27. A battery structure, comprising:
a metal-lithium sulfide-carbon composite cathode;
a silicon composite or a Li-metal anode;
a flexible ceramic separator; and;
a solid state electrolyte.
